(19) United States
(12) Patent Application Publication
(10) Pub. No.: US 2019/0372368 A1
(43) Pub. Date: Dec. 5, 2019

(54) STORAGE AND CHARGING STATION FOR A VAPING DEVICE

(71) Applicant: Ryan Robert Eckerson, Belleville, MI (US)

(72) Inventor: Ryan Robert Eckerson, Belleville, MI (US)

(21) Appl. No.: 16/431,829

(22) Filed: Jun. 5, 2019

Related U.S. Application Data
(60) Provisional application No. 62/680,655, filed on Jun. 5, 2018.

(51) Int. Cl. H02J 7/00; A24F 21/00; A24F 47/00

(52) U.S. Cl. CPC H02J 7/0045; A24F 47/008; A24F 21/00; H02J 7/0027

(57) ABSTRACT

Described herein is a storage and charging station for use in with a vaping assembly and vaping devices. The device includes a base member, at least a pair of cartridge storage receptacles, at least one battery storage receptacle, at least one battery charging stand and at least one USB port. The device includes a power source in a coupling with the at least one battery charging stand, wherein a vaping device can be removably received on the stand of charging the vaping device.

### CROSS-REFERENCE TO RELATED APPLICATION

This Patent Application claims priority to U.S. Provisional Application 62/680,655 filed Jun. 5, 2018 to the above-named inventor, the disclosure of which is considered part of the disclosure of this application and is hereby incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The invention relates generally to a storage and charging station for a vaping device and assembly.

### BACKGROUND

In attempt to deliver a substance to the lungs of an individual a relatively new method and associated apparatuses have been developed to generally vaporize a compound for inhalation. One such device is called a vaporizer or vape pen. A vape pen is generally described as a device including a pair of components in the form of a battery portion and atomizer, cartridge, or cartomizer, as it is sometimes known, utilized in a coupling to form the vape pen.

In a standard configuration, the battery portion is comprised of a lithium-ion rechargeable power source that includes a female threaded portion to receive a correspondingly male threaded portion of the cartridge. The most common configuration is called a “510 thread”, wherein the threaded assembly utilizes ten (10) threads across a height of 0.5 mm. The battery portion is generally operated by a user to generate heat within the cartridge to vaporize the substance within the cartridge.

Accordingly, this assembly configuration allows for easy interchangeability of the cartridges within the battery portion. Additionally, as the battery source is rechargeable it needs to be frequently charged through a coupling with a power source. Typically, this charging is done through the use of a cable in communication with a USB-style charging port or with a dongle or dongle like device that is secured to the battery portion female threaded portion.

Due to this ease of interchangeability, a user will often have multiple cartridges with differing compositions or flavors and may even have multiple battery portions for use with the multiple cartridges. Further, to comply with the best practices for cartridge storage, it is advised that users store the cartridge in an upright position to prevent leaking and damage. Accordingly, as the popularity of the use of vape pens increases there has been established a need for device to aid a user in storing and charging the associated battery portions and multiple cartridges of a user. Preferably, this storage solution stores the cartridges in an upright position, enables the charging of multiple battery portion types and styles, and provides an assembly that is portable and useful.

### SUMMARY OF THE INVENTION

The device of the present disclosure is most generally related to a storage and charging station for a vaporizer device and its included accessories or multiple vaporizer devices and their included accessories. The device is configured to allow for the storage and charging of the vaporizer device in a convenient and organized assembly.

The device of the present disclosure includes a plurality of structural components in the form of a base member, at least a pair of cartridge storage receptacles, at least one battery storage receptacle, at least one battery charging stand, and at least one Universal Serial Bus (USB) port.

The base member functioning as a housing for the electronics of the device generally configured to enable operation of the features of the device. The main electronic components of the device, including, but not limited to, a circuit board, a power source, on/off switch, controller, indicator lights, ports, battery, and other similar elements. The power source generally configured to power the device including providing power to the at least one battery charging stand. The power source can utilize an alternating current from a standard household electrical source or alternately can include an internal battery capable of charging attached devices and use as portable charging device for additional devices.

The base member including a planar surface on an upper portion of the housing structure configured for the placement of the additional features of the device. The at least a pair of cartridge stands received on the planar surface and extending perpendicular opposite the planar surface a predetermined height. The at least a pair of cartridge stands generally forming a raised structure to support a cartridge for a vaporizer in an upright position. In the preferred assembly, the raised structure of the at least a pair of cartridge stands including a plurality of apertures sized for the receipt of the cartridge with the apertures including a gasket member comprised of a flexible material to generally seal and support a retained cartridge within the aperture.

The base member further including a plurality of raised ridges having a height opposite the base member planar surface having a shape corresponding to and aligned with the apertures of the at least a pair of cartridge stands to form a barrier surrounding a cartridge received within the apertures.

The at least one battery storage receptacle generally functioning as a supporting stand and structure configured for the receipt of an assembled vape pen or battery portion in a vertical position. The at least one battery storage receptacle received on the planar surface of the base member and including a riser and holder. The riser affixed to the base portion and extending a height perpendicular opposite the planar surface and coupled to the holder. The riser height being greater than the height of the at least a pair of cartridge stands. The holder generally positioned at an end of the riser opposite the base portion perpendicular to the riser and parallel to the base portion and configured to receive and support a vape pen in a vertical position. In a preferred embodiment of the present disclosure, the holder is a ring with a flexible gasket, wherein the ring forms an aperture having a diameter select to receive a vape pen.

The at least one battery charging stand coupled to the power source and configured for the removable receipt of the battery portion of a vape pen for charging the battery portion. In the preferred embodiment of the present disclosure, the at least one battery charging stand is a male threaded portion comprised of a conductive material and configured for receipt within a female threaded battery portion. Preferably, the battery charging stand is compatible for receipt with a 510 threaded battery device.

Although these are the main the components of the device of the present disclosure, the base portion of the device can be increased in size to allow for several variations of components, wherein the device includes several battery charging stands, multiple battery storage receptacles, several pairs of cartridge stands, and multiple USB ports.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the top of the device, according to the present disclosure;

FIG. 2 shows the right side of the device, according to the present disclosure.

FIG. 3 shows a perspective view of the device, according to the present disclosure;

FIG. 4 shows the left side of the device, according to the present disclosure;

FIG. 5 shows the front of the device, according to the present disclosure;

FIG. 6 shows the rear side view of the device, according to the present disclosure; and

FIG. 7 shows an isometric view of the device with a vaping device, according to the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The device of the present disclosure is most generally related to a storage and charging station for a vaporizer device or vape pen, as it is commonly referred, and its included accessories or multiple vaporizer devices and their included accessories. The device is configured to allow for the storage and charging of the vaporizer device in a convenient and organized assembly. In alternate embodiments, the device of the present disclosure includes a rechargeable battery functioning as a power source for use as a portable charging device for a vaporizer device.

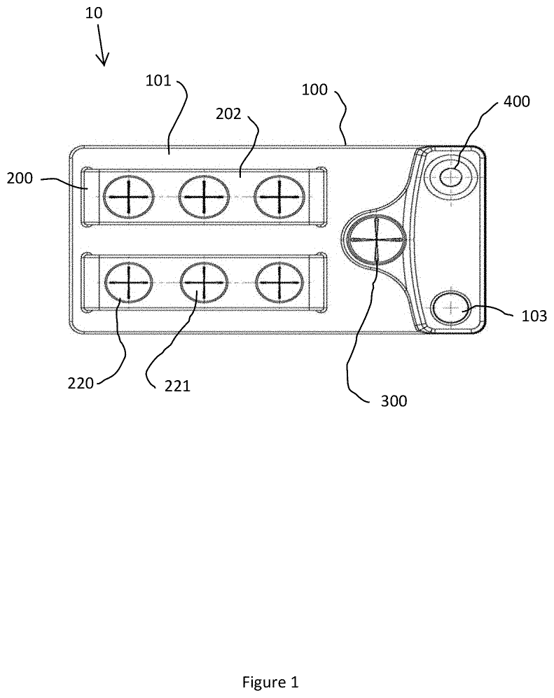

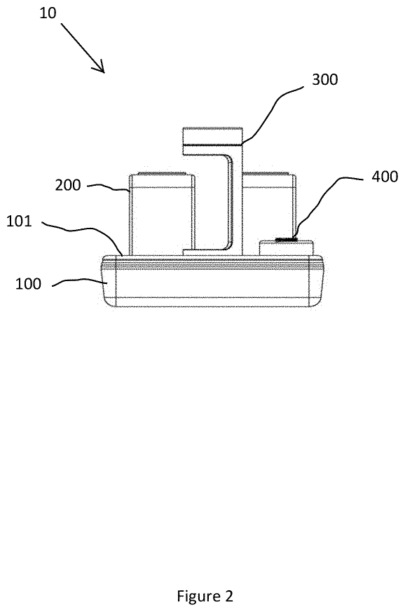

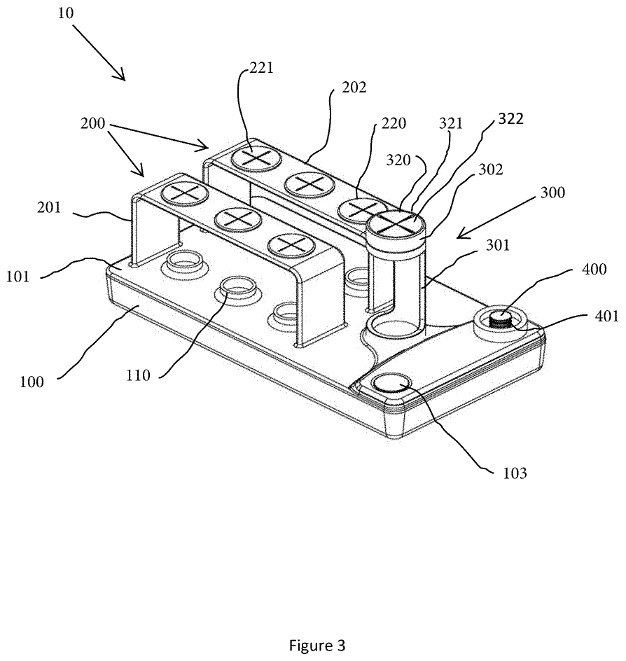

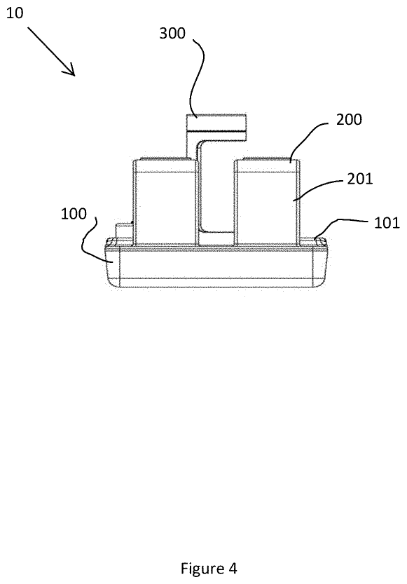

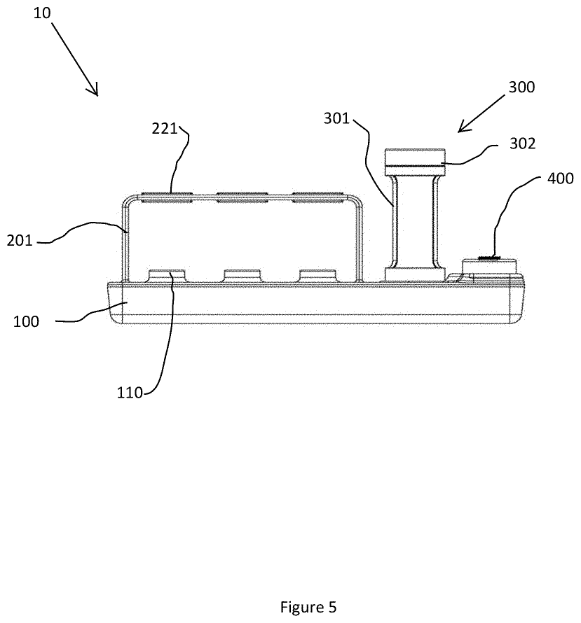

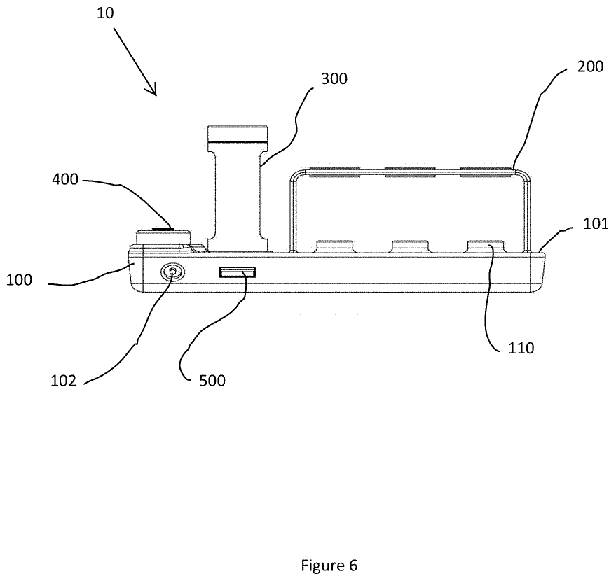

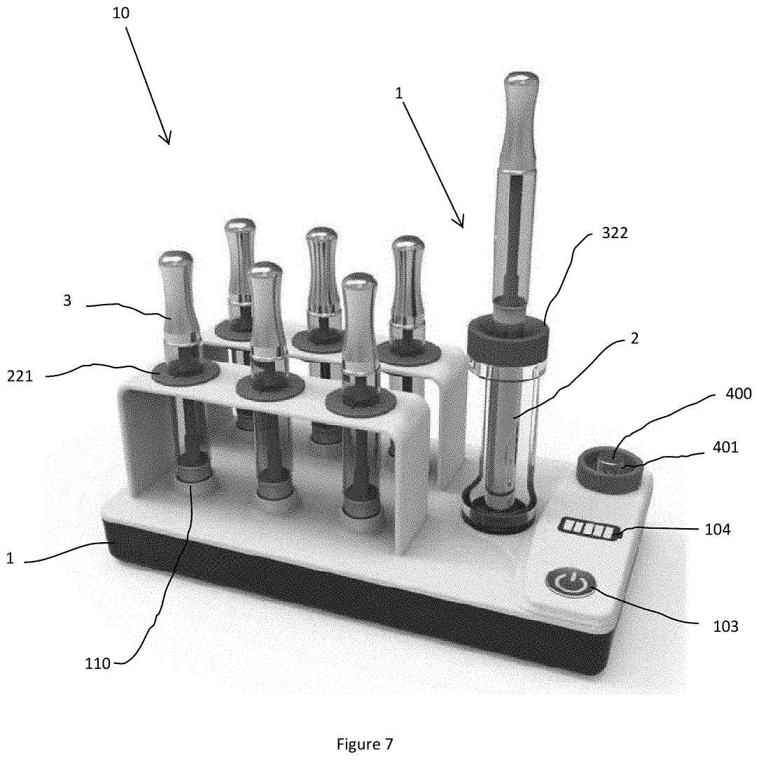

Referring to the figures, FIG. 1 to FIG. 7 show the storage and charging station for a vaping device according to the present disclosure and is generally referred to herein as device 10. The vaping device 1 referred to within this description is herein interchangeably described as a vaporizer, vape pen, or vaping device is device configured to heat a substance into a vapor for inhalation that most generally includes a pair of components in the form of a battery portion 2 and an atomizer, cartridge, or cartomizer portion 3, as it is sometimes known, utilized in a coupling to form the vaping device 1.

The device 10 is intended to provide storage for the vaping device 1 and its associated components in a vertical position to prevent leaks and maintain the integrity of the various connecting portions of the vaping device 1 including threaded connections and electronic components. Accordingly, the device 10 includes a plurality of structural components, including, but not limited to, a base member 100, at least a pair of cartridge storage receptacles 200, at least one battery storage receptacle 300, at least one battery charging stand 400, and at least one Universal Serial Bus (USB) port 500.

The base member 100 generally having a planar upper side 101 and forming a housing for the receipt and placement of the electronics of the device 10 generally configured to enable operation of the various features of the device 10. The main electronic components of the device 10, including, but not limited to, a circuit board, a power source 102, on/off switch 103, controller, indicator lights 104, ports, a battery, and other similar elements. The power source 102 generally configured to power the device 10 including providing power to the at least one battery charging stand 400. The power source 102 can utilize an alternating current from a standard household electrical source. In an alternate embodiment of the present disclosure, the device 10 power source 102 is a built-in rechargeable battery for charging the vape pen 1 when the device 10 is not plugged into an electrical power source. This battery can be recharged through a USB or a traditional power cord with battery and device 10 function controlled by the controller within the base member 100.

The base member 100 planar upper side 101 generally forming a flattened surface for the placement of the additional features of the device 10, wherein this planar upper side 101 functions as the base of the device 10. The at least a pair of cartridge storage receptacles 200 received on the planar upper side 101 extending perpendicular opposite the planar upper side 101 a predetermined height. The at least a pair of cartridge storage receptacles 200 form a stand with a raised structure to support a cartridge 3 for a vaporizer 1 in an upright position. In the preferred assembly, the raised structure of the at least a pair of cartridge storage receptacles 200 formed from a pair of legs 201 extending a predetermined height perpendicular and opposite the planar upper side 101 and a connecting portion 202 extending parallel to the planar surface 101 bridging and connecting the pair of legs 201. The connecting portion 202 including a plurality of apertures 220 sized for the receipt of the cartridge 3. The plurality of apertures 220 including a gasket member 221 coupled within each aperture 220 of the plurality of apertures 220 with the gasket member 221 comprised of a flexible material, such as silicone, or other similar material, to generally seal and support a retained cartridge 3 within a given aperture 220 of the plurality of apertures 220. Accordingly, the plurality of apertures 220 and the gasket member 221 selected with a diameter corresponding to the diameter of the received cartridge 3. In alternate embodiments, the aperture 220 size may be identical with a variety of gasket members 221 utilized to size a given aperture 220 for a given cartridge 3 diameter.

The base member 100 planar upper side 101 further including a plurality of raised ridges 110 having a height opposite the base member 100 planar upper side 101 having a shape corresponding to and aligned with the apertures 220 of the at least a pair of cartridge storage receptacles 200 to form a barrier surrounding a cartridge 3 received within the apertures 220. The raised ridges 110 generally forming a containing area under the at least a pair of cartridge storage receptacles 200 to protect a stored cartridge 3 and prevent contamination and damage to the cartridge 3.

The at least one battery storage receptacle 300 generally functioning as a supporting stand and structure configured for the receipt of an assembled vape pen 1 or battery portion 2 in a vertical position. The at least one battery storage receptacle 300 received on the planar upper side 101 of the base member 100 and includes a riser 301 and holder 302. The riser 301 affixed to the base portion 100 upper planar surface 101 and extending a height perpendicular and opposite to the upper planar surface 101 and coupled to the holder 302. The riser 301 height being greater than the height of the at least a pair of cartridge stands 200. The holder 302 positioned at an end 310 of the riser 301 opposite the base portion 100 perpendicular to the riser 301 parallel to the base portion 100. The holder 302 configured to receive and support a vape pen 1 in a vertical position.

In the preferred embodiment of the present disclosure, the holder 302 of the battery storage receptacle 300 is a ring 320 forming an aperture 321 having a diameter selected to receive a vape pen 1. Preferably, the holder 302 includes a flexible gasket 322 coupled within the aperture 321, wherein the gasket 322 is interchangeable and can be selected by a user corresponding to various diameters of vape pens 1. Further, it is preferred that the holder 302 is constructed of a silicone or silicone-like protective acrylic material to support an assembled vape pen 1 or battery portion 2 when not in use.

The at least one battery charging stand 400 is coupled to the power source 102 and configured for the removable receipt of the battery portion 2 of a vape pen 1 for charging the received battery portion 2. In the preferred embodiment of the present disclosure, the at least one battery charging stand 400 is a male threaded portion 401 comprised of a conductive material and configured for receipt within a female threaded battery portion 2. Preferably, the at least one battery charging stand 400 is compatible for receipt with a 510 threaded battery device. Although the device 10 is shown with a single battery charging stand 400, the device 10 can include multiple charging stands 400 with the each of the multiple charging stands 400 having alternate sizes of the male threaded portion 401 for use with multiple batter portions 2.

The at least one Universal Serial Bus (USB) port 500 received on the base portion 100 in a coupling with the power source 102 and configured for use as a universal port for the connection of standard electronic devices, including, but not limited to vaping devices that are not charged through the standard threaded portion 401.

The device 10 of the present disclosure generally intended to provide a storage portion for several vape pen 1 assemblies and their various items, wherein the base portion 100 of the device 10 can be increased in size to allow for several variations and sizes of components. Accordingly, the device 10 may include duplicative portions, wherein the device 10 includes several battery charging stands 400, multiple battery storage receptacles 300, several pairs of cartridge stands 200, and multiple USB ports 500.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A storage and charging station for a vaping assembly, the vaping assembly including a battery portion and a cartridge portion, the storage and charging station comprising:
a base member;
at least a pair of storage receptacles coupled to the base member and extending a first height;
at least one battery storage receptacle coupled to the base member and extending a second height;
at least one battery charging stand, the at least one battery charging stand coupled to a power source and configured to removably receive the battery portion of the vaping device; and
at least one Universal Serial Bus (USB) port.

2. A storage and charging station for a vaping assembly as in claim 1, wherein the storage and charging station at least a pair of storage receptacles includes a plurality of apertures, the apertures have a size configured to receive the cartridge.

3. A storage and charging station for a vaping assembly as in claim 2, wherein the storage and charging station plurality of apertures have a flexible gasket, the flexible gasket coupled within the plurality of apertures.

4. A storage and charging station for a vaping assembly as in claim 1, wherein the second height of the at least one battery storage receptacle is greater than the first height of the at least a pair of storage receptacles.

5. A storage and charging station for a vaping assembly as in claim 1, wherein the power source is a rechargeable battery.

6. A storage and charging station for a vaping assembly as in claim 1, wherein the at least one battery charging stand is a male threaded portion.

7. A storage and charging station for a vaping assembly as in claim 6, wherein the male threaded portion is compatible with a 510 threaded battery portion.

8. A storage and charging device for a vaping device, the vaping device including a battery portion and a cartridge portion, the storage and charging device comprising:
a base member, the base member forming a housing for a power source and having a planar upper side;
at least a pair of storage receptacles coupled to the planar upper side and extending a first height perpendicular and opposite the planar upper side, the at least a pair of storage receptacles configured to store the cartridge portion in a vertical position;
at least one battery storage receptacle coupled to the planar upper side and extending a second height perpendicular and opposite the planar upper side, the at least one battery storage receptacle configured to store the vaping device in a vertical position;
at least one battery charging stand, the at least one battery charging stand coupled to a power source and configured to removably receive the battery portion of the vaping device; and
at least one Universal Serial Bus (USB) port.

9. A storage and charging device for a vaping device as in claim 8, wherein the storage and charging device at least a pair of storage receptacles includes a plurality of apertures, the apertures having a size configured to receive the cartridge.

10. A storage and charging device for a vaping device as in claim 9, wherein the storage and charging station plurality of apertures have a flexible gasket, the flexible gasket coupled within the plurality of apertures.

11. A storage and charging device for a vaping device as in claim 8, wherein the second height of the at least one battery storage receptacle is greater than the first height of the at least a pair of storage receptacles.

12. A storage and charging device for a vaping device as in claim 8, wherein the power source is a rechargeable battery.

13. A storage and charging device for a vaping device as in claim 8, wherein the at least one battery charging stand is a male threaded portion.

14. A storage and charging device for a vaping device as in claim 13, wherein the male threaded portion is compatible with a 510 threaded battery portion.

15. A storage and charging device for a vaping device, the vaping device including a battery portion and a cartridge portion, the storage and charging device comprising:
a base member, the base member forming a housing for a power source and having a planar upper side;
at least a pair of storage receptacles coupled to the planar upper side and extending a first height perpendicular and opposite the planar upper side, the at least a pair of storage receptacles configured to store the cartridge portion in a vertical position, the at least a pair of storage receptacles having:
a pair of legs, each leg of the pair of legs extending the first height perpendicular opposite the planar upper side;
a connecting portion, the connecting portion coupled to each leg of the pair of legs extending perpendicular to each leg parallel to the planar upper side; and
a plurality of apertures, the plurality of apertures on the connecting portion, each aperture of the plurality of apertures having a size selected to receive the cartridge;
at least one battery storage receptacle coupled to the planar upper side and extending a second height perpendicular and opposite the planar upper side, the at least one battery storage receptacle configured to store the vaping device in a vertical position, the at least one battery storage receptacle having:
a riser, the riser extending the second height perpendicular and opposite the planar upper side; and
a holder, the holder positioned at an end of the riser opposite the planar upper side, the holder receiving the vaping device;
at least one battery charging stand, the at least one battery charging stand coupled to the power source and configured to removably receive the battery portion of the vaping device; and
at least one Universal Serial Bus (USB) port.

16. A storage and charging device for a vaping device as in claim 15, wherein the plurality of apertures have a flexible gasket, the flexible gasket coupled within the plurality of apertures.

17. A storage and charging device for a vaping device as in claim 15, wherein the second height of the at least one battery storage receptacle is greater than the first height of the at least a pair of storage receptacles.

18. A storage and charging device for a vaping device as in claim 15, wherein the power source is a rechargeable battery.

19. A storage and charging device for a vaping device as in claim 15, wherein the at least one battery charging stand is a male threaded portion.

20. A storage and charging device for a vaping device as in claim 19, wherein the male threaded portion is compatible with a 510 threaded battery portion.
